(19) United States
(12) Patent Application Publication
(10) Pub. No.: US 2010/0120009 A1
(43) Pub. Date: May 13, 2010

(54) LEARNING REINFORCEMENT SYSTEM

(75) Inventor: CHRIS AYERS, Glen Allen, VA (US)

Correspondence Address: Thomas, Raring, & Teague, P.C., 536 GRANITE AVENUE, RICHMOND, VA, 23226, US

(73) Assignee: Yukon Group, Inc., Glen Allen, VA (US)

(21) Appl. No.: 12/616,865

(22) Filed: Nov. 12, 2009

Related U.S. Application Data
(60) Provisional application No. 61/199,170, filed on Nov. 13, 2008.

(51) Int. Cl. G09B 7/00

(52) U.S. Cl. 434/336

(57) ABSTRACT

A learning system, method and computer program product is provided that assesses and reinforces the content of learning course. The system sends a plurality of electronic messages to a course participant at a predetermined interval where each message contains at least one of a plurality of questions entered into memory. Each message further comprises at least two possible answers associated with each of the at least one question of the plurality of questions. The system provides means to directly receive and record a participant's selected answer and can also be used to communicate additional information to a course participant. The system tracks and records a number of data points useful to determine an individual participants understanding of the course, the understanding of the participants as a whole, response rates to the electronic message sent to each participant, and the like.

### CROSS-REFERENCE TO RELATED APPLICATIONS

This application claims priority to U.S. Provisional Application No. 61/199,170, filed Nov. 13, 2008, the contents of which are incorporated herein in its entirety.

### FIELD OF THE DISCLOSURE

The present disclosure relates generally to a method and computer program product for reinforcing learning concepts. More specifically, the subject method and computer program product employs electronic communication and other components to deliver a message containing one of a plurality of predetermined questions and corresponding possible answers to each of a plurality of participants in a previous learning course (i.e., training or educational course). The question(s) in each message is related to at least one learning or skill concept taught in the course. Subsequent messages are then sent to each respective participant at a predetermined frequency where each subsequent message contains at least one of the predetermined questions.

### BACKGROUND

There are currently many learning courses offering substantive information, skills, and the like in a variety of topics, fields, and professions. These courses are offered through various means including on-site, web-based, self-directed computer software, telephone-based, or professional/corporate training or education or the like. As an example, courses for professionals to maintain licensing and continuing education requirements are conducted by all of the above techniques. Businesses also encourage or mandate various learning courses to employees where the courses are designed to upgrade employee skills and efficiencies or educate them about new policies, regulations, or the like. For the same or similar reasons, government workers are also often required or encouraged to attend periodic learning courses. Of course, traditional “classroom” and test prep educations courses are increasingly offered through a variety of channels such as those mentioned above.

These learning courses, however, fail to provide periodic “after the course” reinforcement of the information that was imparted to the participants during the course at a set frequency or interval. These learning courses also fail to identify retention and comprehension of the material at periodic intervals after the course ends. As a result, it is often the case that participants (i.e., the “students” or receivers of the information covered by the learning course) do not remember the materials and/or do not actually implement the information that was conveyed. The courses materials also do not change or are not specifically customized for the target audience. Basically, the benefit of the learning course is not maximized, and the course introduces inefficiencies such as lost time, wasted resources, and other opportunity costs.

While many current training courses include some element of “take home” materials, such as outlines, copies of power-point materials, and the like, these items are typically set aside by the participant for future reference. The materials are static, underutilized, do not provide feedback to the participant, and do not provide feedback to the instructor or participant's employer. A corporate human resource department, for instance, cannot discern what, if anything, the participant may have taken from the course other than a typical “3-ring binder that sits on a bookshelf never to be opened again”. It is impossible to gauge the return on investment for the participant or the participant's employer or instructor.

The bottom line is that there are significant deficiencies in the manner learning courses are delivered and evaluated. Current learning course regimes do not maximize retention and fail to provide on-going learning and feedback. For example, an instructor may provide participants with all the relevant information for a given topic, but, if a participant is distracted or forgetful, the information is lost, forgotten, and otherwise not usable by the participant. The instructor may also have critical lapses in the learning materials that are never identified to the instructor.

A learning reinforcement method and computer program product are needed to facilitate the retention and understanding of information conveyed during a learning course. The method and computer product should aggregate data for participants, the instructors, or a third party, such as the participant's employer. As described below, the present method and computer program product substantially depart from the conventional concepts, methods and designs of convention learning programs, and they provide an original method and product for improving the post-course learning and accounting process.

### SUMMARY OF THE DISCLOSURE

In accordance with the present disclosure, a system, method, and computer program product are provided that reinforce learning concepts provided in a training course by sending, via a computer, a plurality of electronic messages to each of a plurality of course participants at predetermined intervals. A learning course is considered to be any educational class, skills training, or the like in which participants (i.e., students) receive information. The course can be on-site, web-based, software-based, self-directed, instructor-led, etc. Each course would include a plurality of participants.

The system, method, and computer program products disclosed herein address the limitations of conventional learning courses by testing the initial retention rate of the materials by the participants and reinforcing the absorption and maintenance of the knowledge or substantive material presented in the learning course. As a result, there is an increased value and/or return on investment associated with the learning course. The detailed disclosure below, in conjunction with the figures, describe communication protocols, networks, databases, and the like used to present or deliver the reinforcement material to a participant, an instructor, or a third party, such as the instructor or participant's employer.

In one embodiment of the method for reinforcing learning concepts, as implemented by a computer, there is first the step of entering a plurality of questions related to at least one learning concept taught by the course. At least two answers corresponding to each of the plurality of questions are also entered. Then, via the computer, a plurality of electronic messages is sent to each participant of the plurality of participants. Each message includes at least one of the previously entered questions. As such, the method further comprises the steps of selecting at least one question and including the selected question(s) and corresponding answers in each message.

The computer sends a first electronic message to each respective participant within a predetermined time period. At least one subsequent message of the plurality of messages is sent via the computer at a predetermined interval.

Each electronic message (email, cellular phone text message, etc.) to each one of the plurality of participants may contain the same question, different questions, or some combination thereof. Each question to include in each of the plurality of messages may be independently selected. The step of selecting the at least one question for the electronic message might also comprise selecting the at least one question randomly from the plurality of entered questions. The question could be selected to ensure that not all participants receive the same question at substantially the same time. In other words, some participants would initially receive a first question while others would receive a second question and still others would receive a third question. Eventually, each participant will receive at least two of the electronic messages where each subsequent message is delivered at any predetermined frequency/interval (hourly, daily, weekly, monthly, etc.).

As noted above, the computer sends the first one of the plurality of messages to each respective participant within or at a predetermined time period from a date of the course. Each course, whether it is on-site, remotely instructed, or self-directed will have a predetermined course end date. The course end date for conventional courses, such as on-site training, would be the final date the participants attend the course. For other courses, such as remotely instructed or self-directed courses, there might be a window of time in which participants are able to participate. The date of the course could be the final date or time in which participants are allowed to receive the course information. Alternatively, the date of the course could be a starting date of the course, or a date at which a specific segment/module/topic began or ended. It is also possible to designate arbitrary dates for the date of the course. In any event, subsequent messages are also sent via the computer to each respective participant at a predetermined frequency/interval.

In another embodiment of the disclosed method, the method further includes the step of determining, for each sent electronic message, whether each participant has selected an answer. The elapsed time since sending the electronic message is also determined. The elapsed time is compared to a predetermined time limit. A reminder electronic message is sent to participants who have not selected an answer if the elapsed time exceeds the predetermined time limit. The overall participation rate and each participant's particular participation rate can be tracked for each electronic message associated with a course.

Still further, the electronic messages each include the means to enable a participant to select an answer. For example, the answer may be selected by sending an email reply, a reply text message, or other electronic reply message. The reply messages would be transmitted back to the computer implementing the method, or to a separate computer. The means to enable the participant to select an answer may also comprise two or more hyperlinks embedded in the message where each hyperlink is associated with one of the possible answers. As would be known to one of skill in the art, a hyperlink is a link from a hypertext document to another section, document, or Internet location activated by selecting the hyperlink. Here, selecting the hyperlink would cause the computer to record the participant's answer to the question in the electronic message.

In yet further embodiments, each predetermined and entered possible answer corresponding to each of the plurality of questions has an associated correctness value. The value can be a value on a scale or based on a simple designation of “correct” or “incorrect”. The computer/server or an administrator receives selections from one or more of the plurality of participants and determines and records the correctness value for each received answer. The determined correctness values for each received answer selection can be associated with the corresponding participant. As such, it is possible to determine a cumulative grade for each participant based on the determined correctness value for all received answer selections for each participant. In addition, an administrator may create groups/sub-groups of participants within the larger participant pool where the groups are based on the participant's job responsibilities, available demographic information, or a host of other factors. The ‘scores’ for the groups/sub-groups can then be compared so as to draw conclusions about the course materials, make group comparisons, and the like.

To this end, it would also be possible to generate a report comprising the cumulative grade for each participant, the determined correctness value for each received answer selection for any one participant or all participants who selected an answer, a cumulative correctness value for each question for all participants who selected an answer, or a participant response rate for each question. The determined cumulative grades for any one participant may also be compared to the determined cumulated grade of all other participants.

The questions can also be categorized by topic and sub-topic so that the report may further consist of a cumulative correctness value by topic and/or subtopic for all questions to which participants selected an answer. The instructor, the instructor's employer, or a participant's employer can identify “problem areas” by studying the report information. It will be possible to determine if one or more groups of participants may have trouble with or, on the other hand, mastery of certain topics. The report can thereby be used to allocate resources efficiently. That is, one need not invest in additional education on a particular topic or skill if the prospective participant has mastered the course material and vice versa.

The subject method, in yet another embodiment, may also maintain organizational relationship information. The information would be used to control access to the report, selected answers, participant response rates, and the like. An administer could enter the organization relationship information, i.e., designate managers, bosses, supervisors, and the like, so that only certain persons within an organization could access certain information recorded by the learning reinforcement system.

It is further noted that one embodiment of the method might, as a response to each selected answer, send an electronic response message to the participant who selected the respective answer. The electronic response message would include the associated correctness value corresponding to the respective participant's selected answer along with feedback specific to the respective participant's selected answer. For example, the feedback might explain why the selection was correct, incorrect, or better or worse than the other available answer selections. The electronic response message might further include information comparing the respective participant's answer selection correctness value to other participants' answer selection correctness values, a hyperlink to information comparing the response for each participant that had replied, one or more hyperlinks to external reference material for review, and/or the like.

The computer program product for reinforcing leaning concepts disclosed herein would comprise at least one computer-readable storage medium having computer-readable program code stored therein. The computer-readable code sends, by the computer, a plurality of electronic message to each of a plurality of participants in a previous training course. Each one of the plurality of messages includes at least one question and two or more corresponding possible answers. Each question is related to at least one learning concept taught in the course. A first message is sent within a predetermined time period of a date of the course and subsequent messages to each respective participant are sent at predetermined intervals or frequency. Alternative embodiments of the invention may comprise a system for reinforcing learning concepts.

As will be understood by one of skill in the art, the learning reinforcement system presents many advantages and features that result in a new methodology and product for assessing and maintaining information conveyed in a learning course. The subject method and product overcome a number of shortcomings recognized in the prior art. Other functions, advantages or features of the present invention will become obvious to the reader in light of the subject disclosure. To the accomplishment of the above and related functions, advantages or features, this invention may be embodied in the form illustrated in the accompanying drawings, attention being called to the fact, however, that the drawings are only illustrative. Changes may be made in the specific graphics or method as illustrated without leaving the scope of the invention.

While the above summary highlights particular features of the method in order that the detailed description thereof may be better understood, and in order that the present contribution to the art may be better appreciated, there are additional features of the invention that will be described hereinafter.

### BRIEF DESCRIPTION OF THE DRAWINGS

Various other objects, features and attendant advantages of the present invention will become fully appreciated as the same becomes better understood when considered in conjunction with the accompanying drawings wherein:

FIG. 1 is a schematic block diagram of a computer network in which embodiments of the present invention may operate;

FIG. 2 is a diagram of the internal structure of a computer associated with the computer network of FIG. 1;

FIG. 3 is a top-level flowchart depicting a one embodiment of the method and computer program product as disclosed herein;

FIG. 4 is illustrative of a group or sub-group of participants where each participant interacts with the system as disclosed herein;

FIG. 5 is procedural flow chart depicting the configuration and steps of the computer program product and method as disclosed herein;

FIG. 6 is a flowchart providing additional detail thereof;

FIG. 7 is a flowchart providing additional detail thereof;

FIG. 8 is a flowchart providing additional detail thereof; and

FIGS. 9-27 are representative screen shots of the subject system, method, and computer program product as disclosed herein illustrative of the configurations, settings, report information, content, security, automation, and the like as provided thereby.

### DETAILED DESCRIPTION

Turning now to a more detailed description of the present invention, it is to first be understood that the aspects of the subject method and product need not be described inasmuch as certain aspects will be known to those skilled in the art, and/or the details are evident given the illustrations. It is expected that one of skill in the art will understand, for example, the operation and creation of hyperlinks, web page design and creation, interactions with graphical user interfaces, and the like.

The present disclosure is directed to a method, system and computer program product for reinforcing information presented in a learning course. More specifically, the subject method, system and computer program product employs electronic communication and other components to deliver a message containing one of a plurality of predetermined questions and corresponding possible answers to each of a plurality of participants in a previous learning course (i.e., training or educational course). The question(s) in each message is related to at least one learning concept (skill, information, topic, etc.) taught in the course. Subsequent messages are then sent to each respective participant at a predetermined frequency where each subsequent message contains at least one of the predetermined questions. The method, system and computer program product increase comprehension and absorption of the course material, provide data necessary to evaluate the course materials, participants, and/or instructor, and allow for the more efficient and effective allocation of resources, particularly within organizations that rely on periodic learning courses for skills, training, or other education of persons in the organization.

It should be understood that “electronic messages”, as used herein, comprise any and all electronic messages pushed to a course participant including, but not limited to, electronic mail (email), simple text messages, multimedia messaging service (“mms text”), instant messaging, tweets (status updates posted on Twitter™), and the like. These electronic messages may be pushed to a participant's computer (desktop, laptop, mobile, etc.), cellular telephone or other mobile telecommunications devices, or any suitable device for receiving electronic messages. A learning course can comprise any course where information is conveyed by an instructor, computer program product, and the like to a course participant. “Participant” and “student” may be used interchangeably throughout the disclosure.

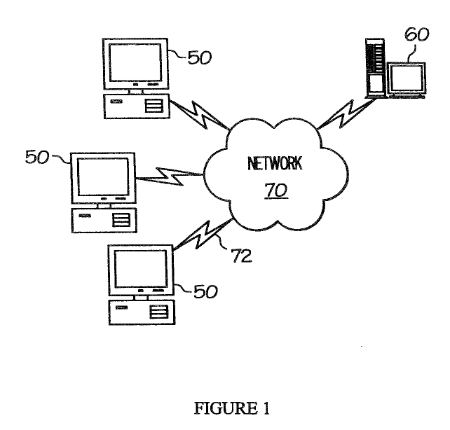

Turning to FIG. 1, there is illustrated a schematic block diagram of a computer network in which embodiments of the present invention may operate. Computers 50 and server 60 (i.e., a computer that provides access to shared resources) provide processing, storage, and input/output devices executing application programs and the like. Computers 50 may be linked over communication link 72 through communications network 70 to each other and to other computing devices, including server 60. Communications network 70 can be part of the Internet, cellular network(s), a worldwide collection of computers, networks, and gateways that currently use the TCP/IP suite of protocols to communicate with one another. The Internet provides a backbone of high-speed data communication lines between major nodes or host computers, consisting of thousands of commercial, government, educational, and other computer networks, that route data and messages. However, computers 50 and server 60 may be linked over any suitable communication network. In the system of FIG. 1, computers 50, such as cell phones, may be running Web browsers, email clients, or text or instant messaging programs used for accessing, view, or interact with websites or documents such as may be hosted on server 60. In this arrangement, accessing and viewing websites includes downloading and updating display elements (such as HTML elements) and data from the server 60 to the computers 50. Likewise, emails may contain HTML elements.

In addition to the client-server arrangement of FIG. 1, embodiments of the invention may operate in any client-server arrangement or in any networked arrangement in which display elements, data, and/or other information are sent from a source to a recipient. For example, embodiments of the invention may operate in a mobile communications/data architecture (such as a mobile telecommunications network adhering to the International Mobile Telecommunications-2000 (also termed 3G) standards), in which a mobile telecommunications device (e.g., cell/mobile telephone) is the recipient.

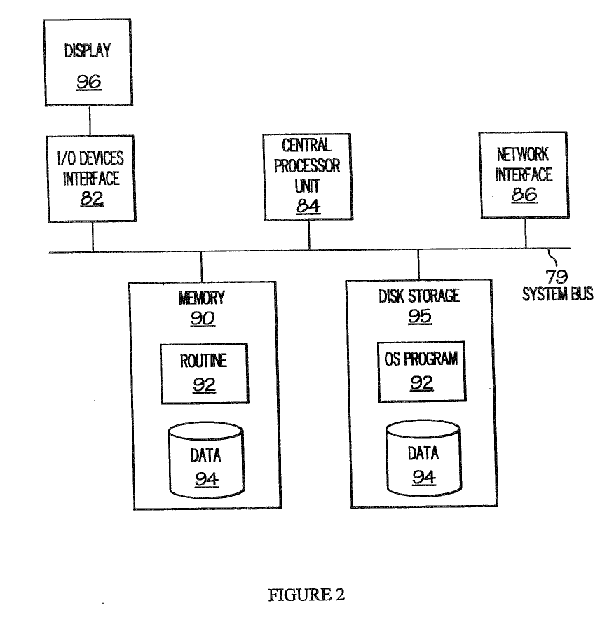

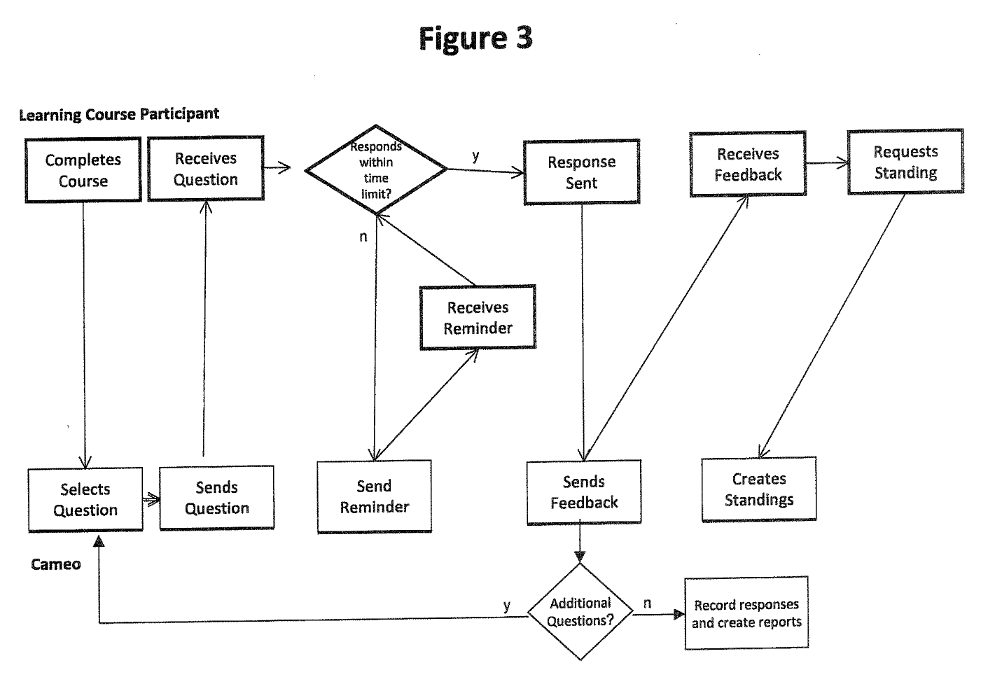

FIG. 2 is a diagram of the internal structure of a computer (e.g., computers 50 or server 60) in the computer network of FIG. 1. Each computer typically contains system bus 79, where a bus is a set of hardware lines used for data transfer among the components of a computer. Bus 79 is essentially a shared conduit that connects different elements of a computer system (e.g., processor, disk storage, memory, input/output ports, network ports, etc.) that enables the transfer of information between the elements. Attached to system bus 79 is I/O device interface 82 for connecting various input and output devices (e.g., displays 96, printers, speakers, etc.) to the computer. Network interface 86 allows the computer to connect to various other devices attached to a network (e.g., network 70 of FIG. 3). Memory 90 provides volatile storage for computer software instructions used to implement an embodiment of the present invention. Disk storage 95 provides non-volatile storage for computer software instructions and data used to implement an embodiment of the present invention. Central processor unit 84 is also attached to system bus 79 and provides for the execution of computer instructions.

As will be appreciated by one skilled in the art, the present invention may be embodied as a system, computer-implemented method or computer program product. Accordingly, the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, the present invention may take the form of a computer program product embodied in any tangible medium of expression having computer-usable program code embodied in the medium.

Any combination of one or more computer usable or computer readable medium(s) may be utilized. The computer-usable or computer-readable medium may be, for example but not limited to, an electronic, magnetic, optical, electromagnetic, infrared, or semiconductor system, apparatus, or device. More specific examples (a non-exhaustive list) of the computer-readable medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, or a magnetic storage device. Note that the computer-usable or computer-readable medium could even be punch-card, paper or another suitable medium upon which the program is printed, as the program can be electronically captured, via, for instance, optical scanning of the paper or other medium, then compiled, interpreted, or otherwise processed in a suitable manner, if necessary, and then stored in a computer memory. In the context of this document, a computer-usable or computer-readable medium may be any medium that can contain or store the program for use by or in connection with the instruction execution system, apparatus, or device.

Computer program code for carrying out operations of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

The present invention is described herein with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable medium that can direct a computer or other programmable data processing apparatus to function in a particular manner, such that the instructions stored in the computer-readable medium produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide processes for implementing the functions/acts specified in the flowchart and/or block diagram block or blocks.

The flowchart and block diagrams in the figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

“Computer” or “computing device” broadly refers to any kind of device which receives input data, processes that data through computer instructions in a program, and generates output data. Such computer can be a hand-held device, laptop or notebook computer, desktop computer, minicomputer, mainframe, server, cell phone, personal digital assistant, other device, or any combination thereof.

FIG. 3 illustrates one method and computer program product flowchart for a learning course participant's interaction with the subject computer program product (commercially referred to as Cameo®). As identified, subsequent to a participant finishing a learning course, the Cameo learning system selects a question, where the question might be about a hypothetical or fact-based scenario, and includes the selected question in an electronic message to the participant. The question and/or scenario providing by the electronic messages relates to one or more topics or other information conveyed by the learning course. The electronic message will also include at least two possible answers that correspond to the question.

In one embodiment, the participant responds to the question directly within the electronic message. For example, the message might comprise an email with hyperlinks, text message with website URLs, and the like where the participant is directly, electronically linked to the Cameo learning system to indicate the participant's selection.

The participant is allowed a predetermined time period in which to reply to the question sent by Cameo. If the participant fails to reply within the time limit, Cameo provides a reminder or copy of the electronic message until such time that the participant replies to the electronic message. Each electronic message could indicate the deadline to the participant.

It is envisioned that there will be a limit as to the number of reminders to be sent. If the limit of number of reminders is reached, Cameo records the participant's failure to respond. If the student/participant does not respond within the set time limit or before the expiration of the set number of reminders, a reminder or message might also be sent to the instructor or participant's employer.

The possible answers, in one embodiment, can be assigned a correctness value. That is, some answers might not be the best possible answers but are otherwise acceptable alternative choices. The participant's response to Cameo will indicate the participant's answer choice, and each choice can be associated with feedback stored in the Cameo learning system. The subject system provides the feedback regarding the participant's choice to the participant via an electronic response message.

For example if the course being reinforced is a cooking course and the topic is “milkshakes”, the scenario/question sent in an electronic message to a participant might be “When making a chocolate milkshake, what is the first thing to add to the mixing cup?” The possible answers associated with the question and their associated correctness values might be “(a) the milk (10 points), (b) the salt (0 points) and (c) the chocolate ice cream (8 points).” However, the participant will not know the associated correctness value until they have made their choice or until the later check their scores relative to other participants. Once the answer selection is sent to the Cameo system or computer program product, feedback can be presented to the participant. For example, the feedback for the above question might read, “While choice (c) is acceptable, choice (a) is the best choice because it will prove easier to thoroughly mix the ingredients. Of course choice (b) in this example is incorrect, since salt is not an ingredient of a chocolate milkshake.” The feedback may or may not include the associate correctness value for one or all of the possible answer choices.

The Cameo learning system will provide subsequent questions to the participant at predetermined intervals or at a predetermined frequency. By doing so, the subject system comprises a method, system and computer program product that keeps the learning course “top of mind” and reinforces the learning concepts at the predetermined frequency for a set period of time. For instance, the Cameo system might be configured to send four questions related to a learning course. One of the four questions would be sent once a week. The participant therefore revisits the content of the learning course for one month following the completion of the course.

In the above example, another topic of a cooking course might be “ice cream sundaes”. A question with associated answers choices would be sent to the participant at fixed interval from the first question regarding milkshakes. Each topic can have multiple questions as well. The delivery frequency of each electronic message is customized within Cameo.

The Cameo system can be further configured, as described further below and in the related figures, to send the same question to each participant, a random question from the plurality of questions entered into Cameo, or otherwise ensure that, to the extent possible, the participants do not receive the same question from the predetermined questions. In other words, if it is desired that participants engage in a group discussion, the same question from the plurality of questions could be sent to each of the respective participants. On the other hand, to determine individual knowledge, the Cameo system might be configured so as to minimize the number of participants receiving a particular question sent at a given interval. As an example, for a learning course with 12 participants where four predetermined questions are entered into the Cameo computer program product, Cameo might be configured so that participants 1-3 receive a first question, participants 4-6 receive a second question, participants 7-9 receive a third question, and participants 10-12 receive the fourth question. At the next interval, each group of participants would receive another of the plurality of questions without the question overlapping between the groups of participants.

As further illustrated in FIG. 3, the subject system can be configured to maintain a participant standing as well as other reporting information at all times. Customizable reports, which could be accessed “on-line”, printed, or electronically saved to local memory, can be generated to track the retention of the course material for any one or all participants.

As will be discussed further below, organizational or demographic information can also be used to configure the Cameo computer product with sub-groups of participants. The response rates, accumulated correctness value, or other data can be aggregated for each participant, sub-group, or the entire class of participants in the course.

Access to the reporting components of the Cameo computer product can similarly be determined by the organizational information entered into the Cameo system or specific access rights can be provided by a Cameo administrator. As such, an instructor may or may not have access rights within the Cameo system to see the reporting data. Particular participants, the participants' employers, key organizational members, instructors, and the like might optionally be granted access to the reporting data. It is envisioned, for example, that participants will be able to request data as to their accumulated correctness value relative to other participants (i.e., the participant's standing relative to their peers). This “leader board” creates a potentially competitive environment that encourages responses and thoughtful answers. However, participants might not necessarily be able to access other participants response rates, the selected answers attributed to specific other participants, the accumulated correctness value of one sub-group relative to another sub-group, and the like.

The Cameo computer program product, system and related method increase retention by periodically querying the course participants. It also increases understanding of the course materials by providing instant feedback regarding a participant's selection, as also illustrated by FIG. 3. The feedback will explain why a selection might be right or wrong and why the other selections could be more or less correct than the participant's selection. Course providers, course instructors, or the participants' employers for any given course, including test preparation courses (MCAT, LSAT, SAT, professional licensing courses, etc), can use the aggregated data to identify topics or issues where the participants are not absorbing the course material and then commit additional resources to those topics/issues. Additionally, the course might be modified for future iterations as to account for the data recorded by the Cameo computer program product, system and method.

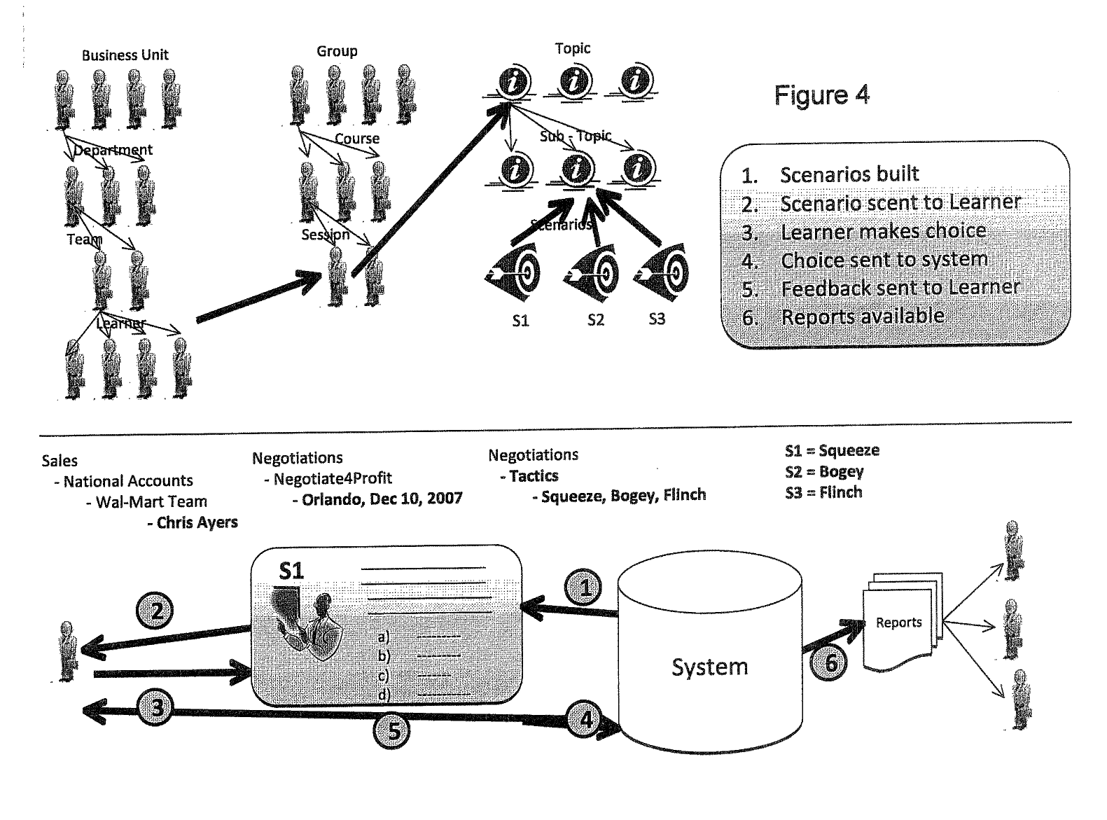

Turning now to FIG. 4, there is illustrated the use and method of the Cameo computer product in a corporate setting. Participants/learners of a business entity are selected for each business unit, department, and/or team. These learners comprise different groups associated with the learning course. A number of topics and/or sub-topics are presented to the participants. As illustrated, one sub-topic might be “negotiation tactics” as presented in connection with the course “Negotiate4Profit” to the sales and/or other teams of a national retailer.

The topics and sub-topics to be reinforced are identified, and the course instructor or an administrator creates questions and answers for use by the Cameo system. The plurality of questions, including the associated possible answers for each question, are entered into the Cameo system. As illustrated in the graphics of FIG. 4, the Cameo system selects the questions and includes the questions in an electronic message sent to the participant/learner. The participant makes a choice from the possible answers associated with the received question. The participant's choice is sent to the system, and predetermined feedback is sent to the user. Reports are available to one or more persons associated with the business entity.

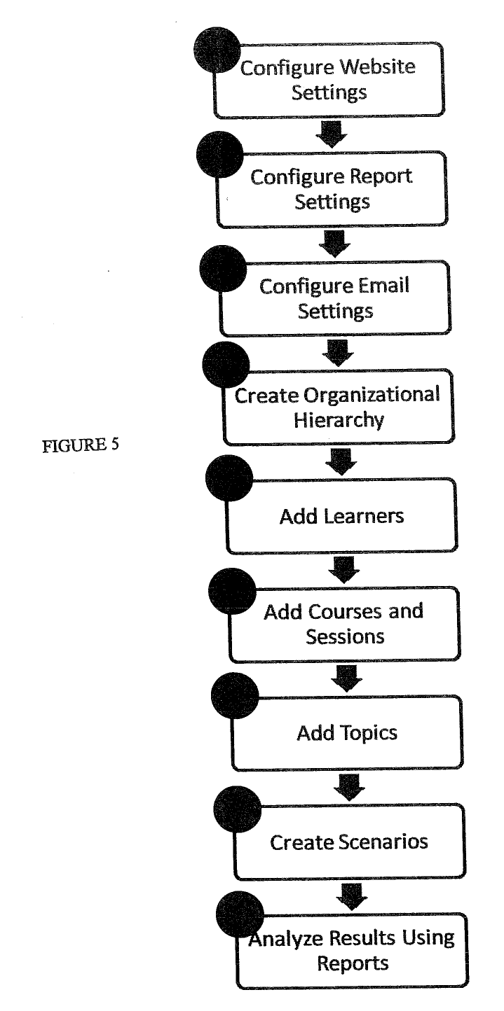

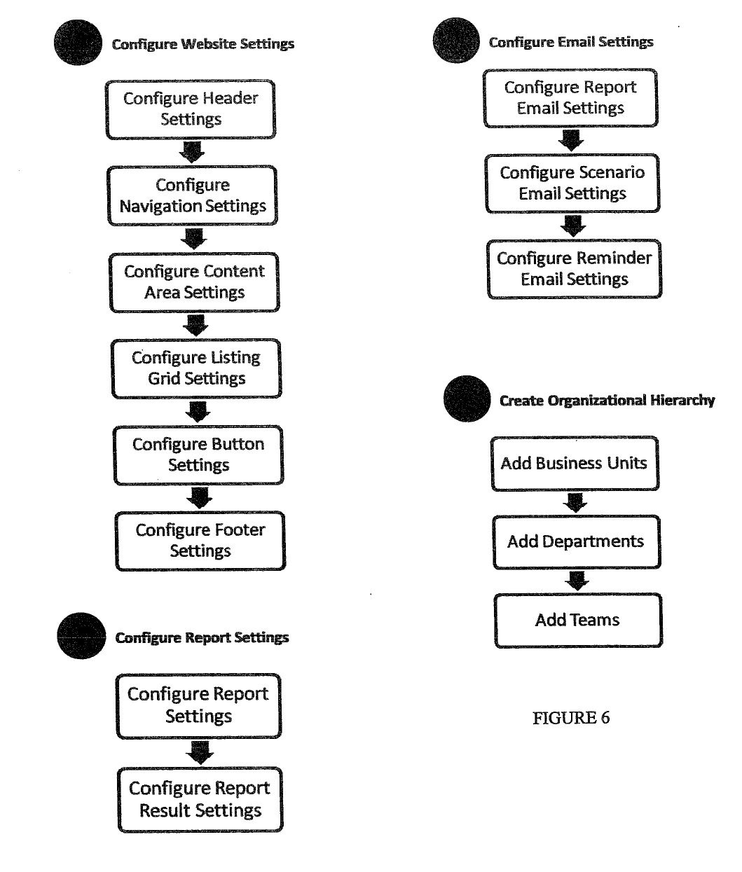

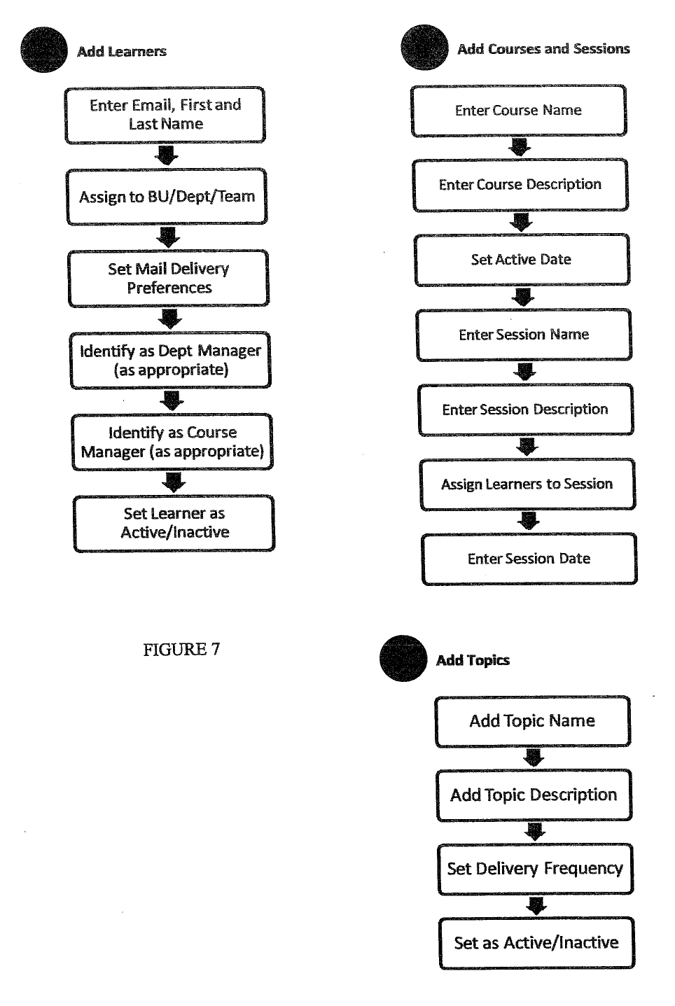

Having illustrated the general operation, FIGS. 5-8 further detail the configuration and operation of the Cameo computer program product, method and system. The interaction with the Cameo computer product might operate on a local computer where the product is configured by a graphical user interface. In many instances, the Cameo computer product will operate on a server accessed via a website. An instructor or administrator will remotely log-in to the Cameo computer product, and the interface and content will be customized to the particular user. Multiple users may be able to access a particular course created within the Cameo computer product, but varying levels of access and control can be assigned to each of the difference users.

Overall, an administrator or course instructor can optionally configure and customize many aspects of the product for use with a particular course. With respect to the website, it is possible to configure, by known means, the header, navigation, content area, listing grid, button and footer settings. Basically, the ‘appearance’ settings of the electronic messages, graphical user interface, and/or web portal provided by system and computer program product can be customized. Likewise, the administrator or person with access to the Cameo computer product would configure the appearance settings/configuration for the reports that result from the operation or execution of the Cameo method, system or computer program product.

Particular fields and content of the electronic messages, such as email settings, can also be configured. As such, the settings for the report email, scenario email, and reminder email can be configured. For example, the message “from”, “subject”, “salutation”, and other fields can be customized and configured. Details such as the screen width (in pixels), colors, and other items may also be customized.

Each course can have an organizational hierarchy associated with the course. The hierarchy would comprise, in a corporate context, the business units, departments, teams, etc. that will participate in a course. In other courses, such as test preparation courses, the hierarchies might be created between first-time test takers, repeat test takers, or along other lines. It would also be possible to use demographic information for the hierarchy or group/sub-group creation. In any event, at this stage, the groups and subgroups can be identified and manually added to the system.

Once the groups are determined and added, assuming the participants will be divided into groups at all, then the participants/learners are added to the system. Each participant can be identified by an anonymous identifier (where privacy is a concern) or, more commonly, simply by name. An email address or other delivery address (i.e., cell phone number) is associated with each participant for the later delivery of the plurality of electronic messages. Assuming groups were created, the participants are assigned to the relevant team or group/sub-group. Likewise, the participants might be associated with particular managers or supervisors as determined by the organizational hierarchy. A “course manager” (instructor, instructor supervisor, etc.) has the ability to see reports for some or all individuals who have taken the course(s) they have been assigned management responsibility for. There may be a plurality of course managers, as needed or desired.

The Cameo system also permits the configuration of email delivery preferences. For example, one could send electronic messages as emails in an HTML format, text messages with or without hyperlinks, or as a message that simply contains a text or hyper-link to a web-based representation of the question/scenario. In this manner, Cameo system and computer program product and the associated method might primarily be a web-portal where the participant views and answers questions hosted on a remote server as opposed to selecting links within an email pushed to the user.

The courses, and any sub-sessions of the courses, are also added with a course name, course description, active date, session names and descriptions (if applicable), learners assigned to the course or sessions and the session date. Topics to be discussed in the course and sessions are also assigned a topic name and description. A delivery frequency for electronic messages associated with each topic is configured, and the topics are selectively activated and deactivated to either enable or discontinue deliver of electronic messages associated with the topic.

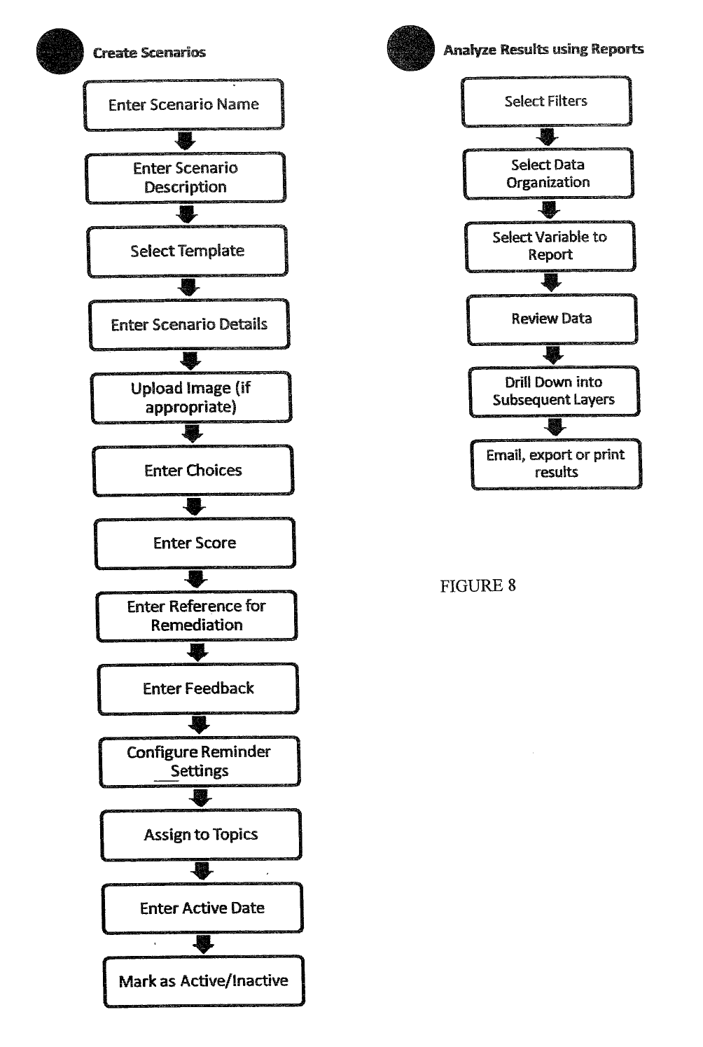

Questions about the topic(s), as interchangeably referred to as scenarios in FIG. 8, are assigned names and descriptions. The user selects from a number of question templates or creates a custom template. The question is entered in computer readable memory. An image may be associated with the question, if desired and appropriate. The at least two possible answers/choices are generated for each question. Optionally, scores (“correctness value”) might be associated with each choice or the choices may simply be scored as “correct” and “incorrect”. Feedback for any or all choices is entered into memory along with relevant reference materials (including web address information for direct hyperlinks to the reference materials, if applicable). The reminder settings can be configured, including the total number and frequency of reminders for any sent electronic message.

The questions are assigned or associated with the proper course topic. The questions for each topic can have independent “active” date and can further be activated or inactivated, as needed.

The final operation and configurations options relate to the reporting component of the Cameo learning system. A user who has the appropriate access to the reports first selects the applicable report filters. Filter include the ability to select a specific segment of an organizational hierarchy, a course or a specific session of a course, and a topic or sub-topic. The filters can be subdivided into still further layers of data. The resulting report can be emailed, exported, or printed so as to share or record the course results.

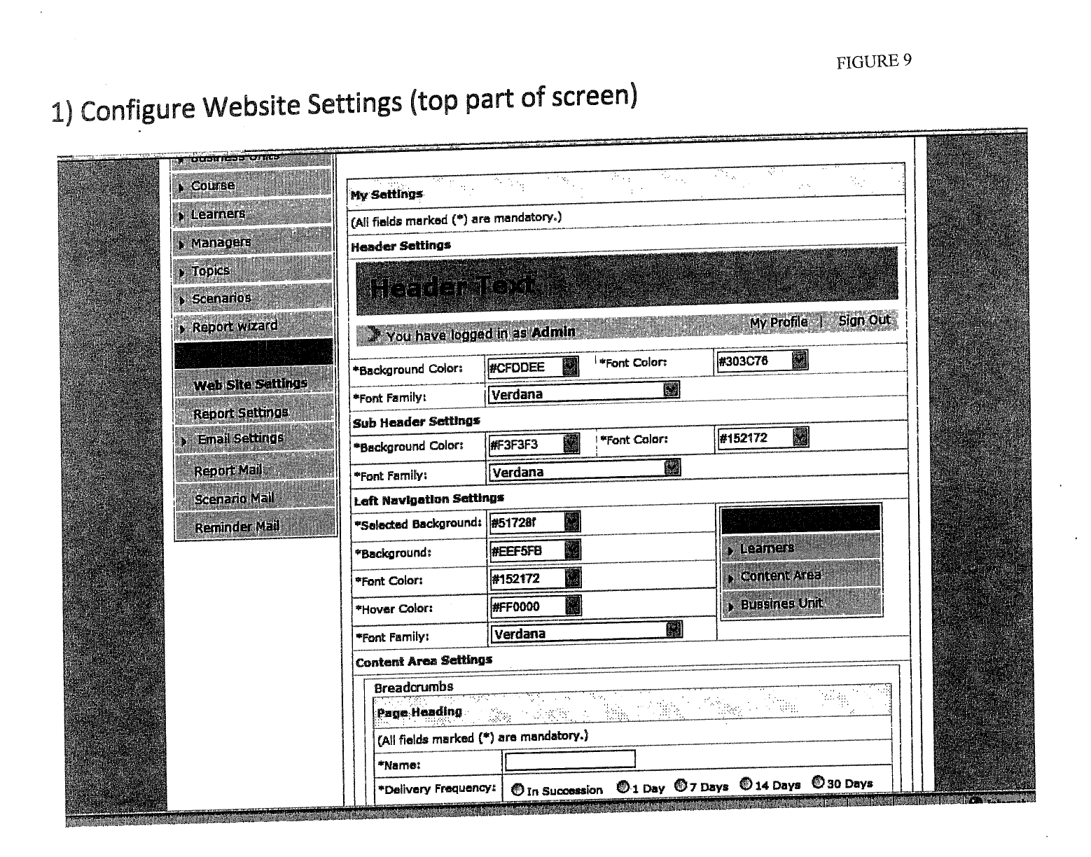

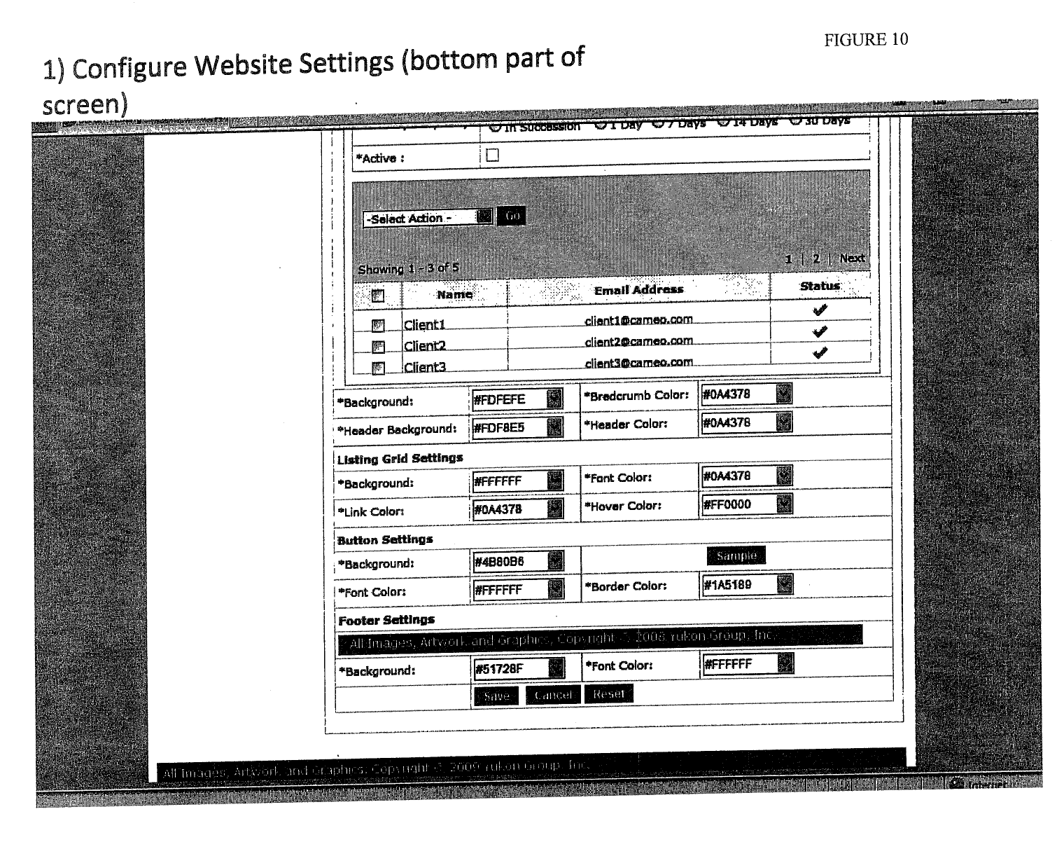

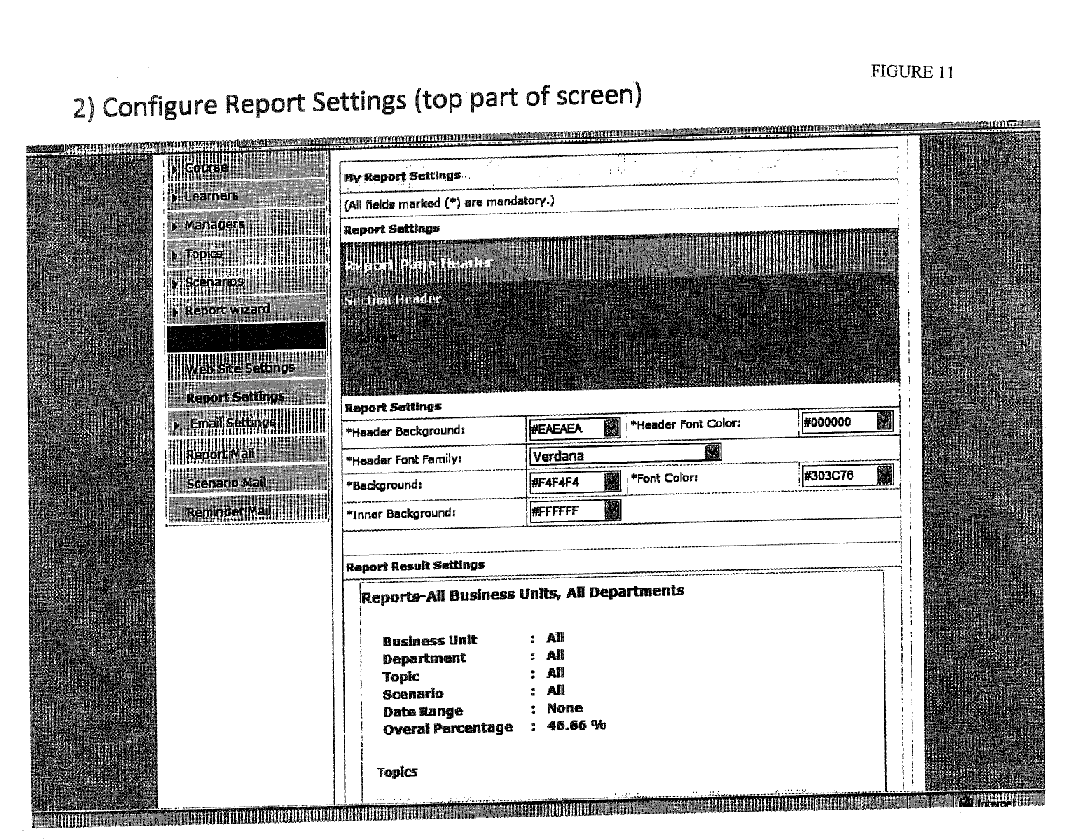

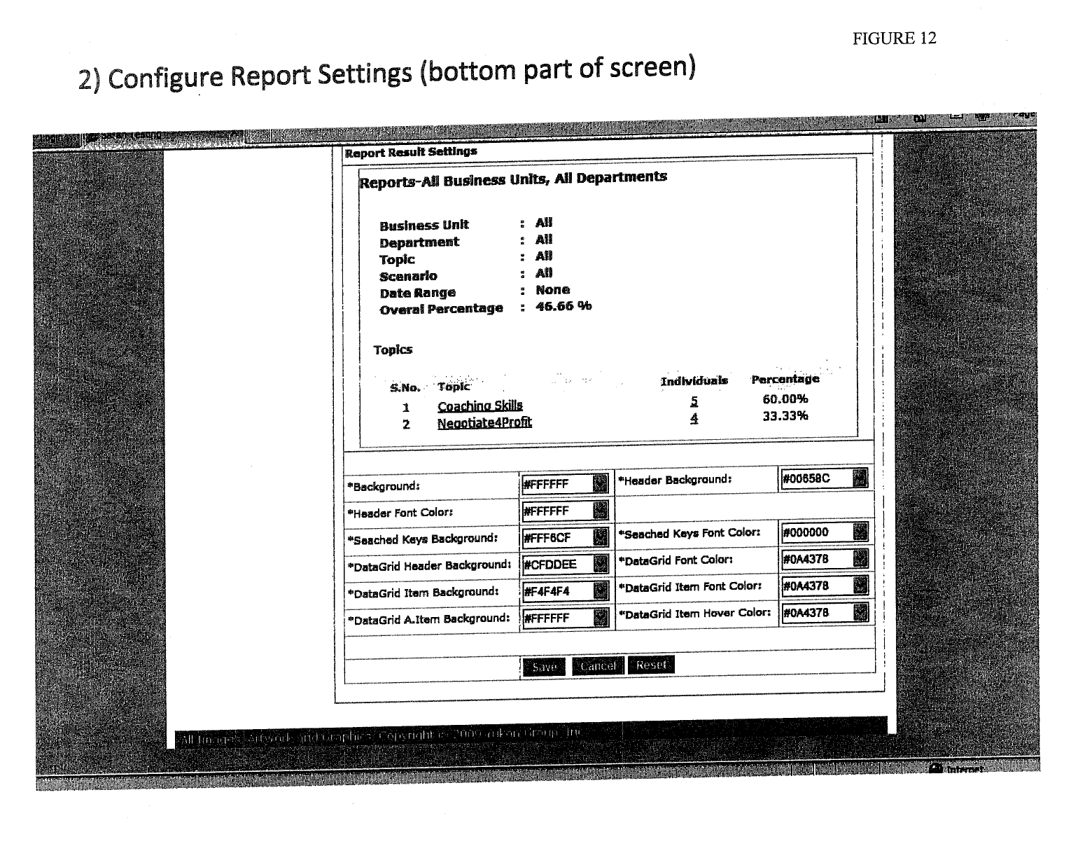

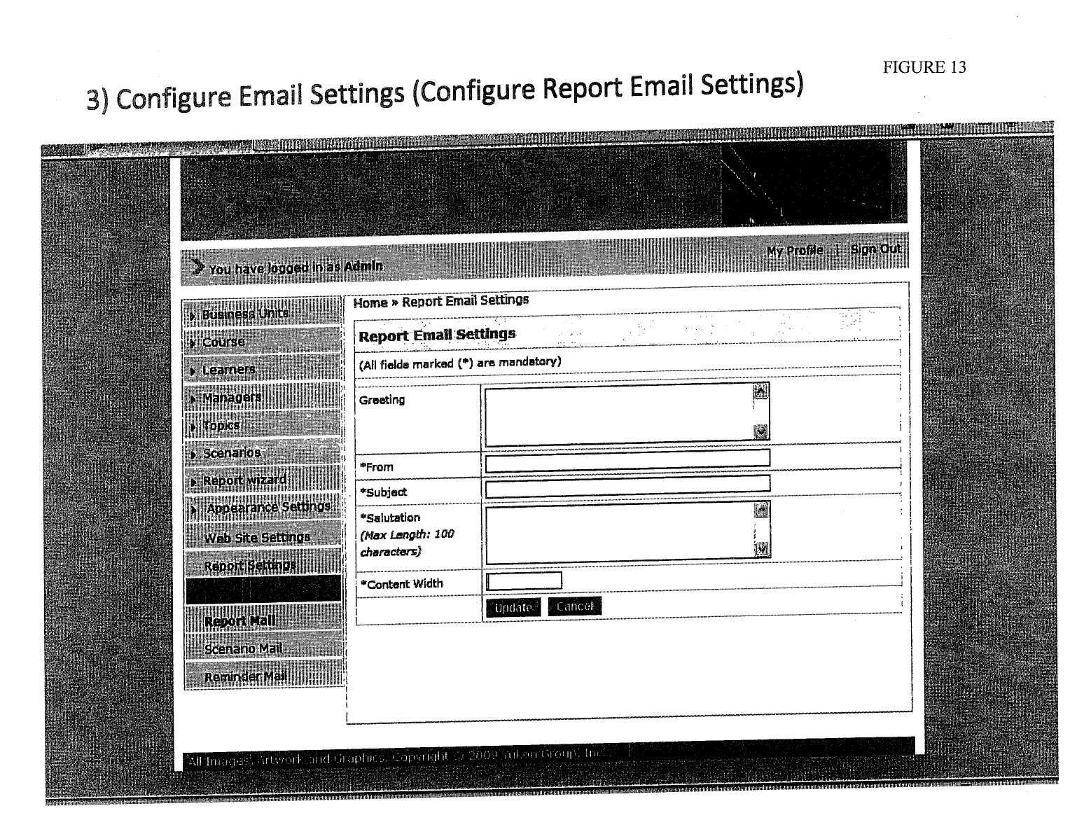

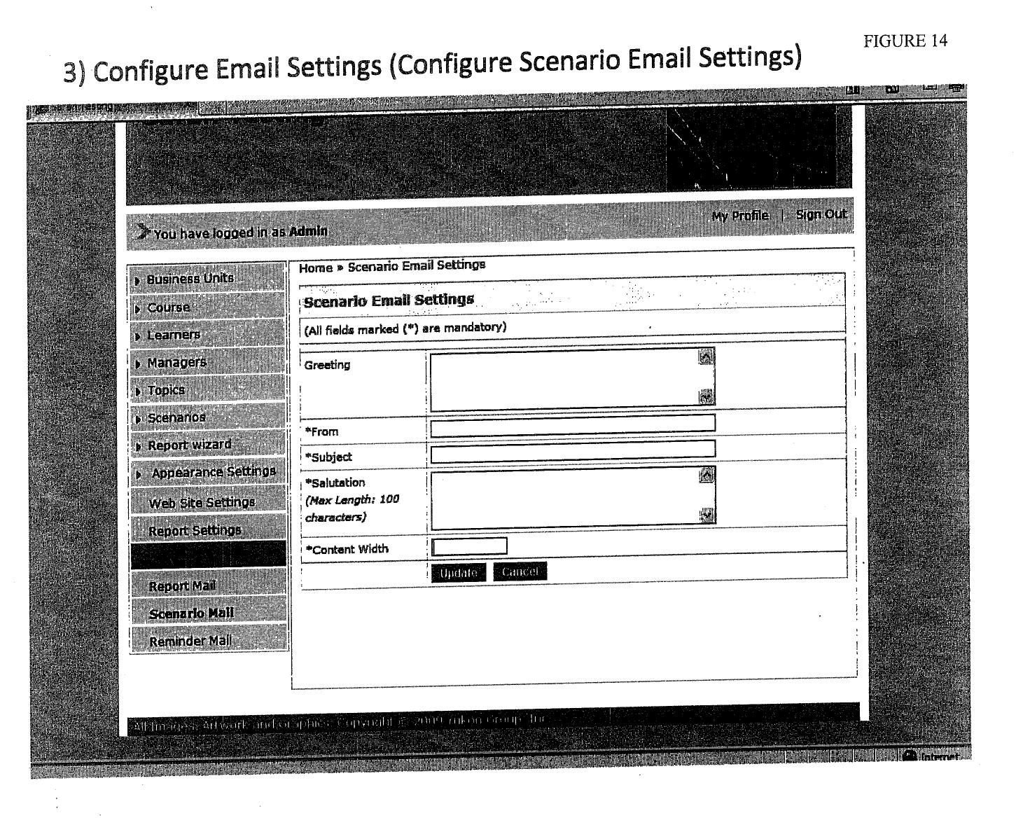

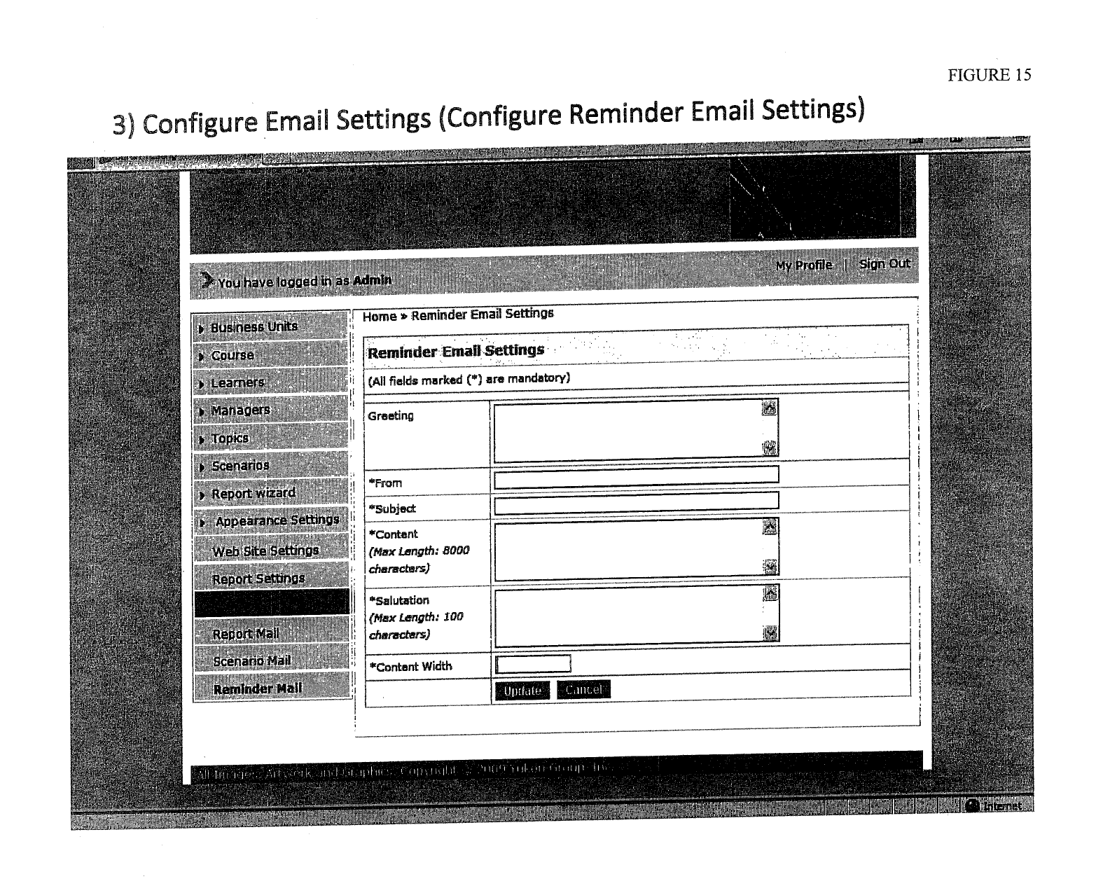

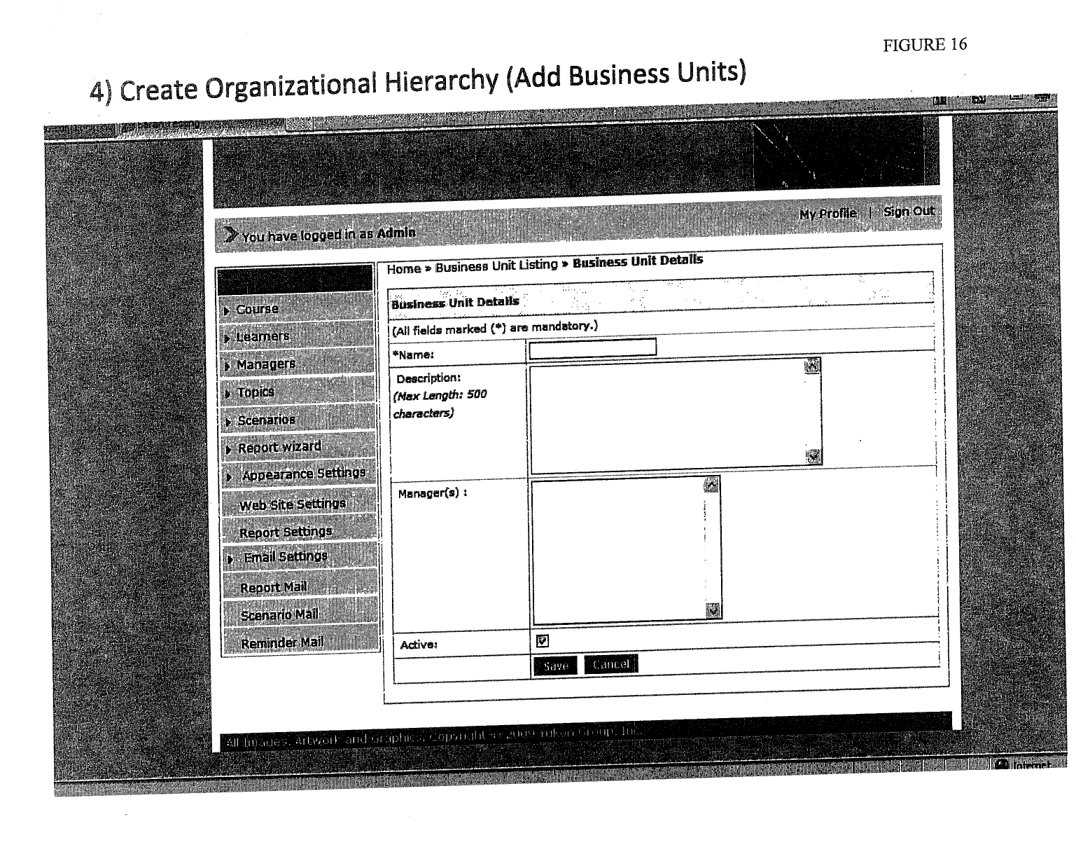

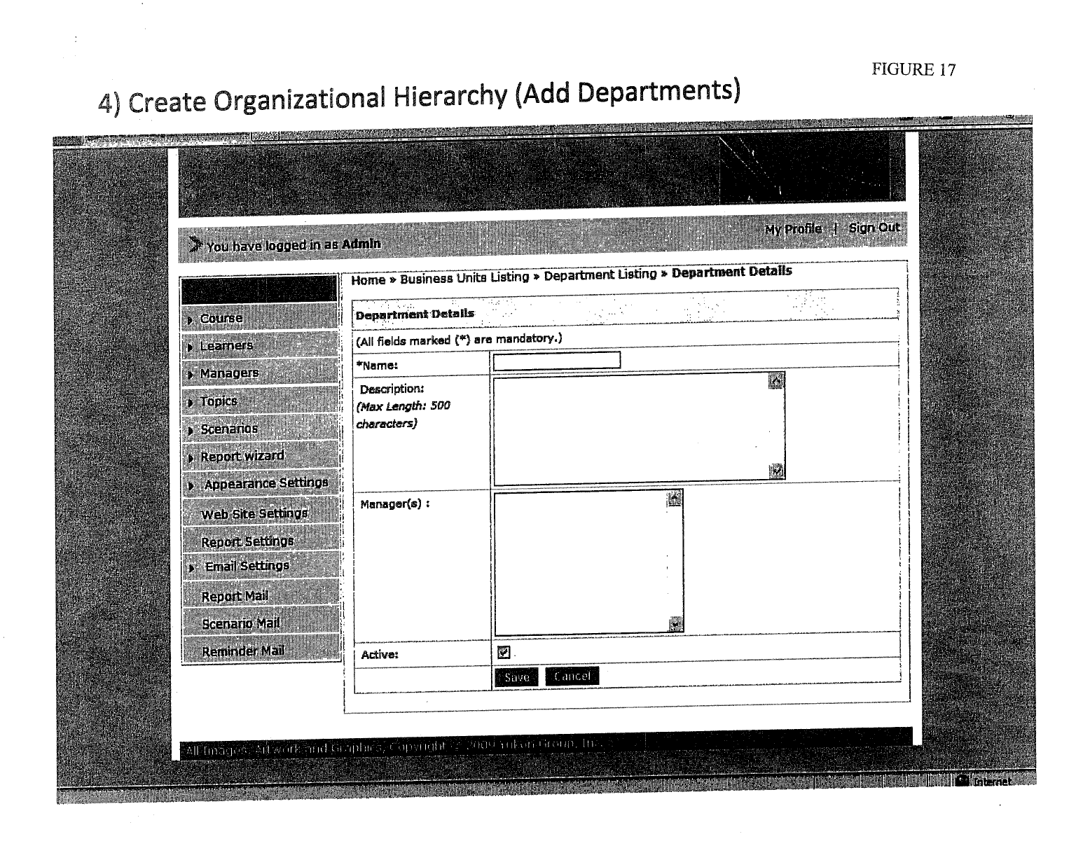

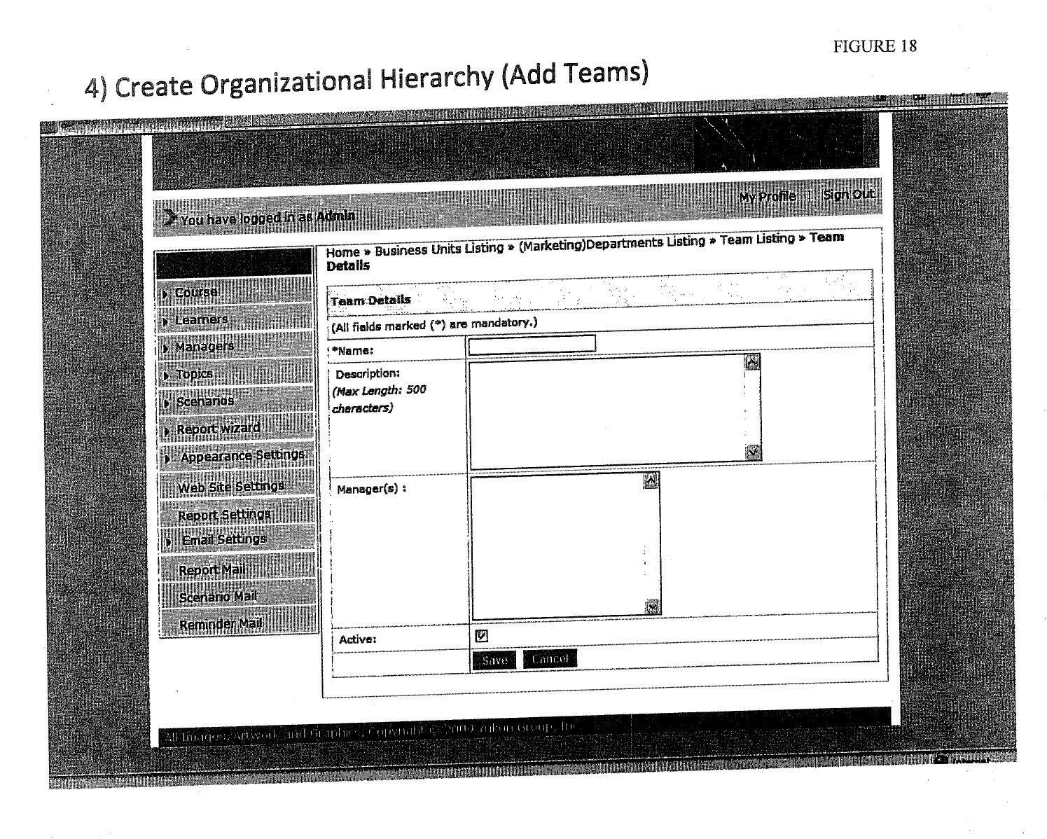

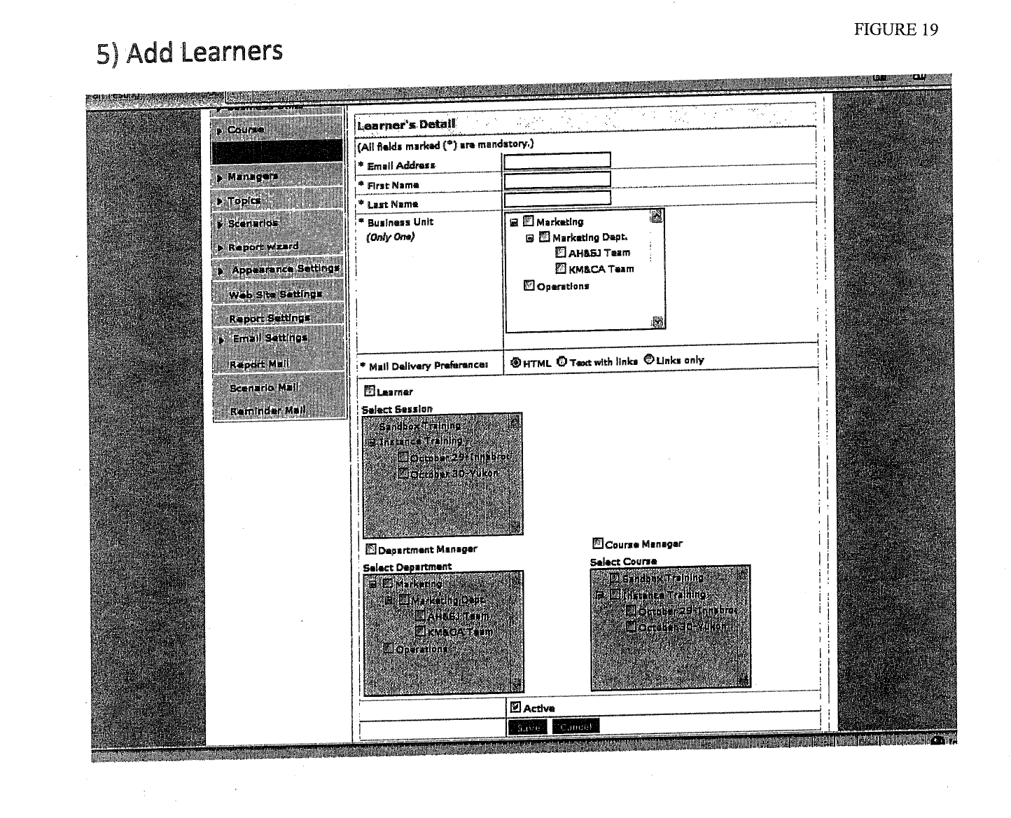

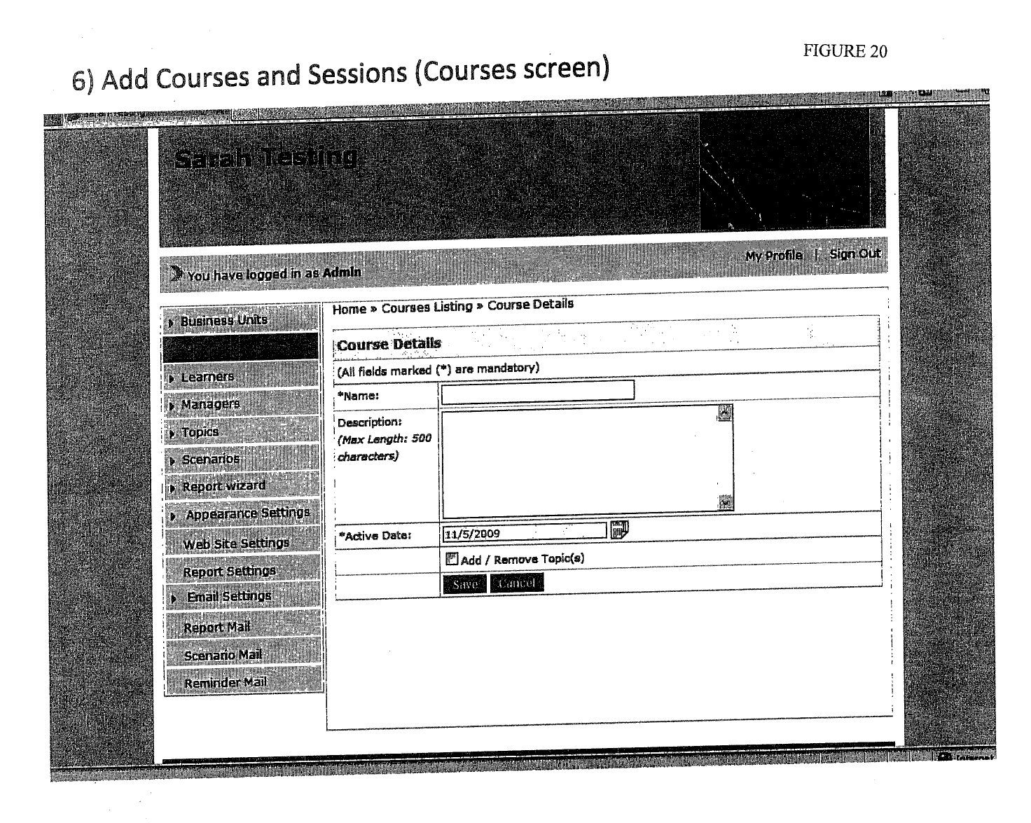

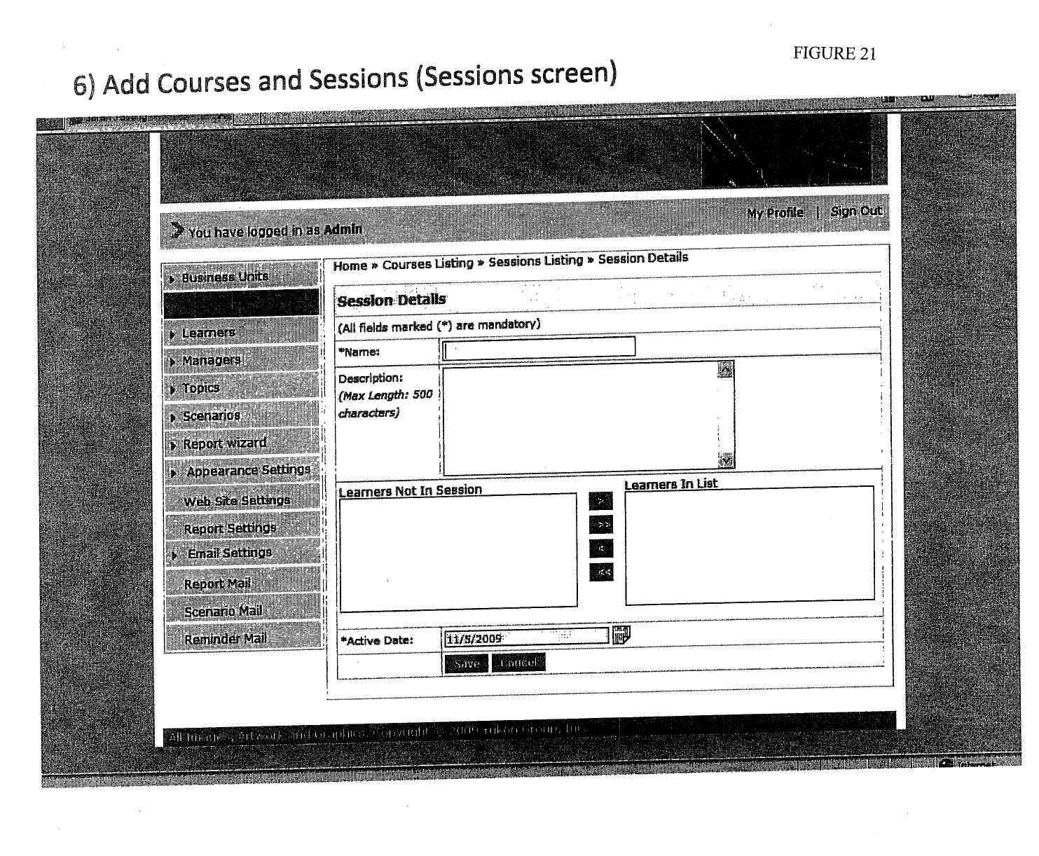

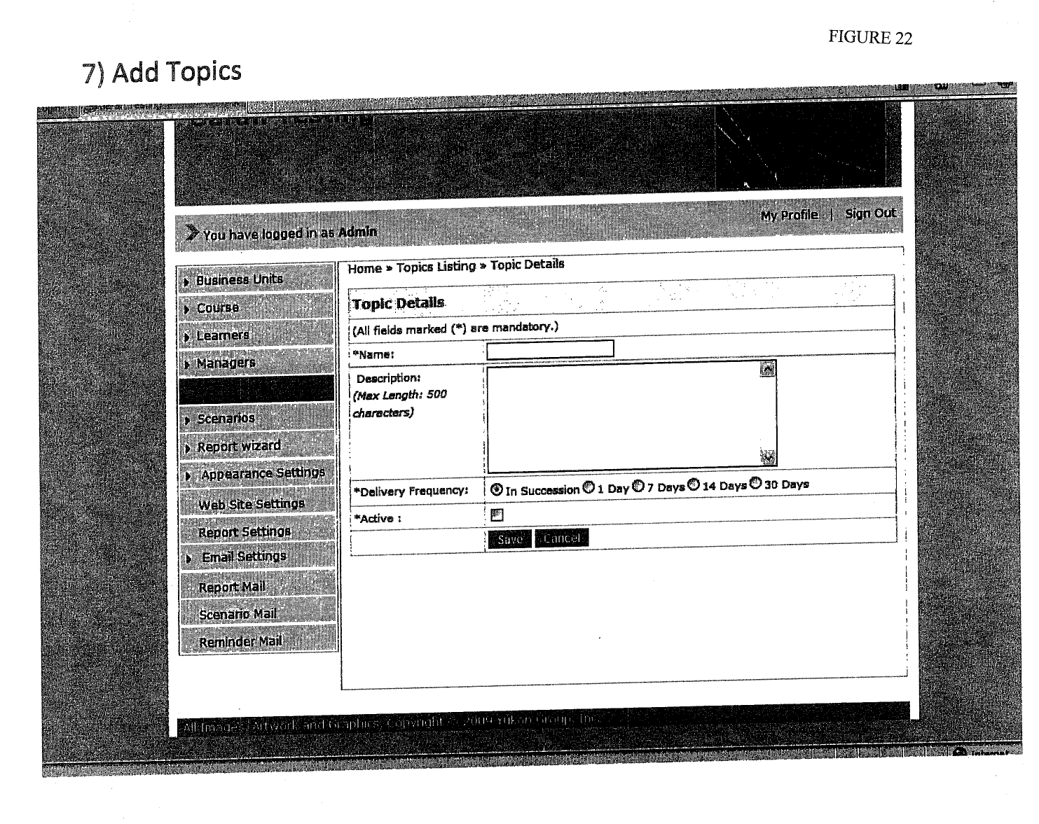

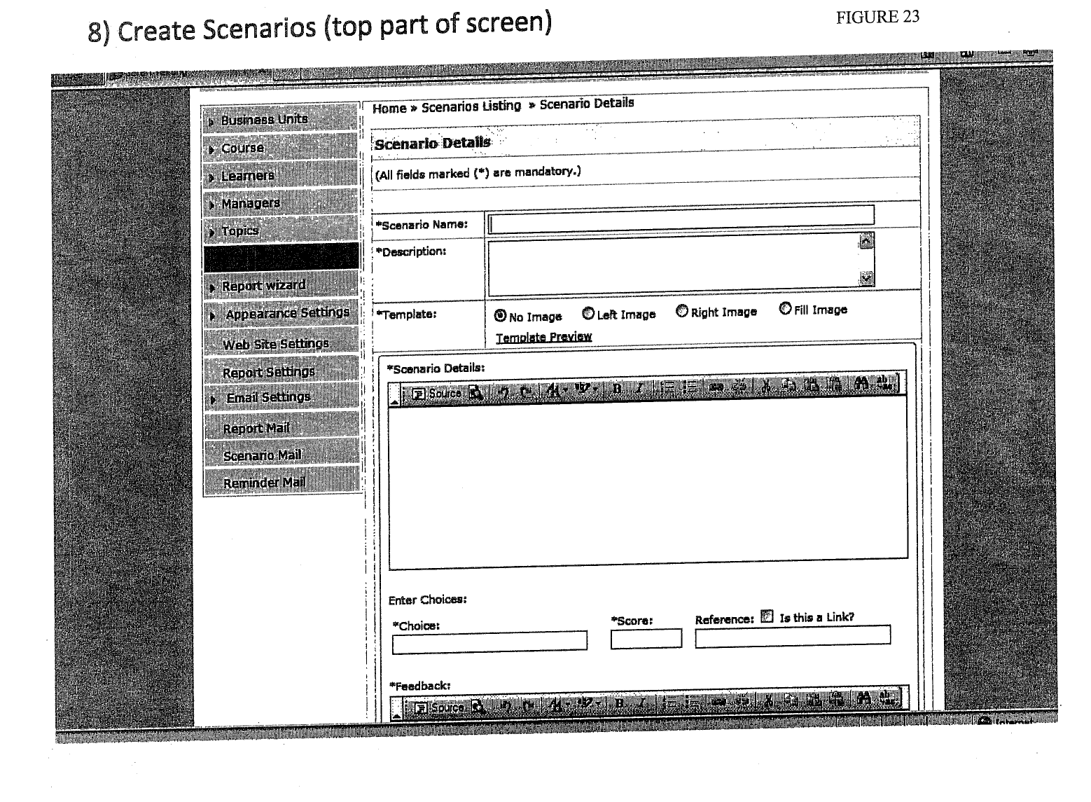

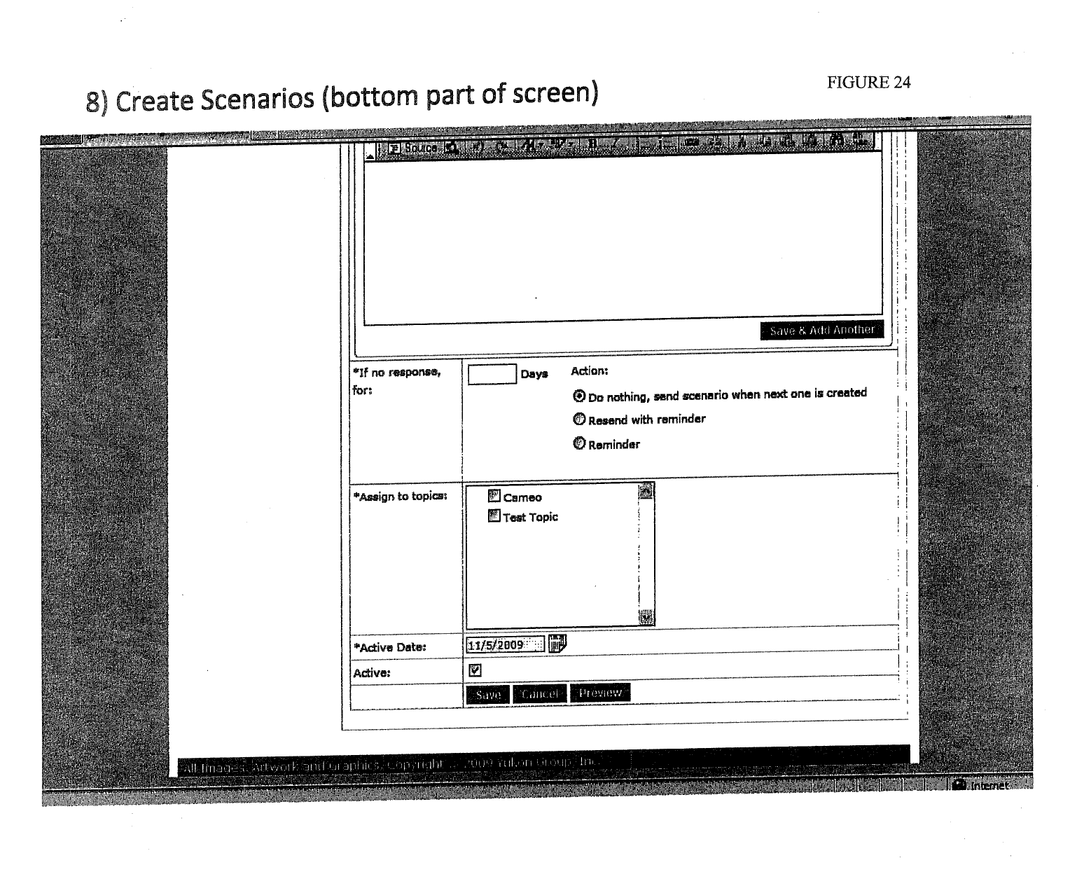

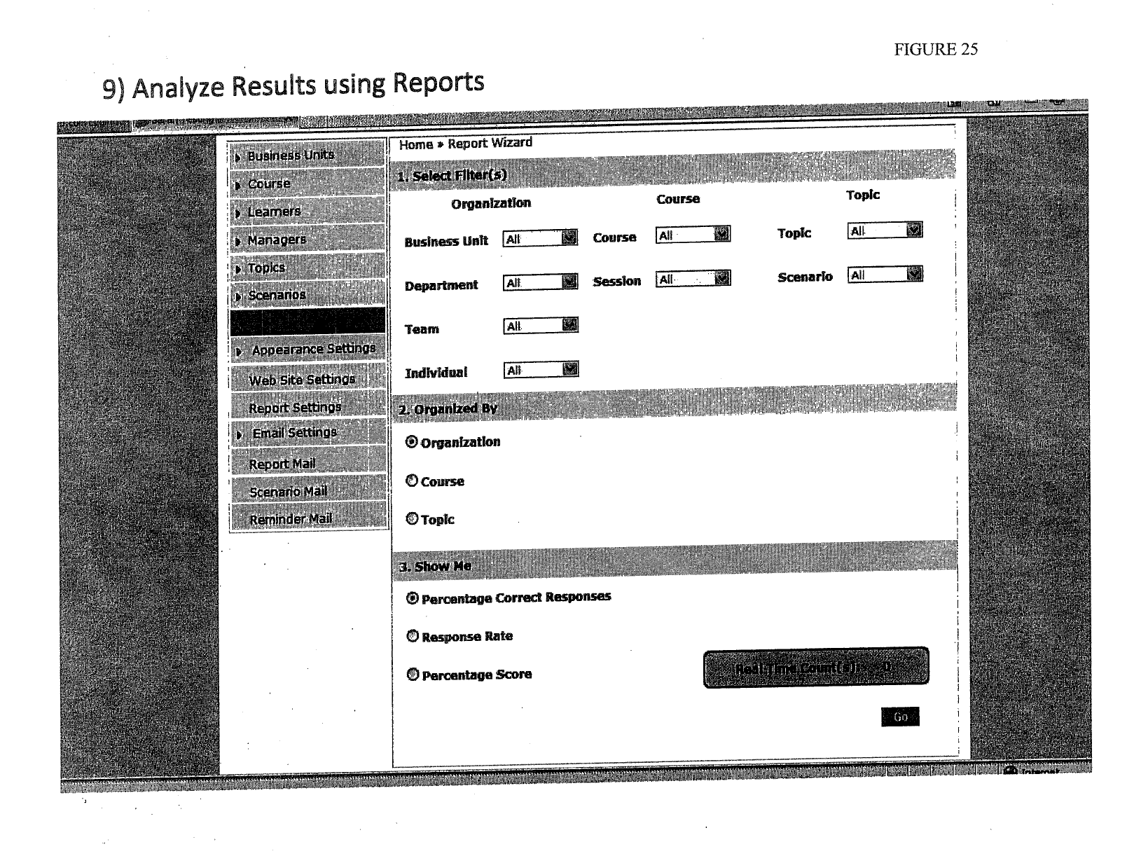

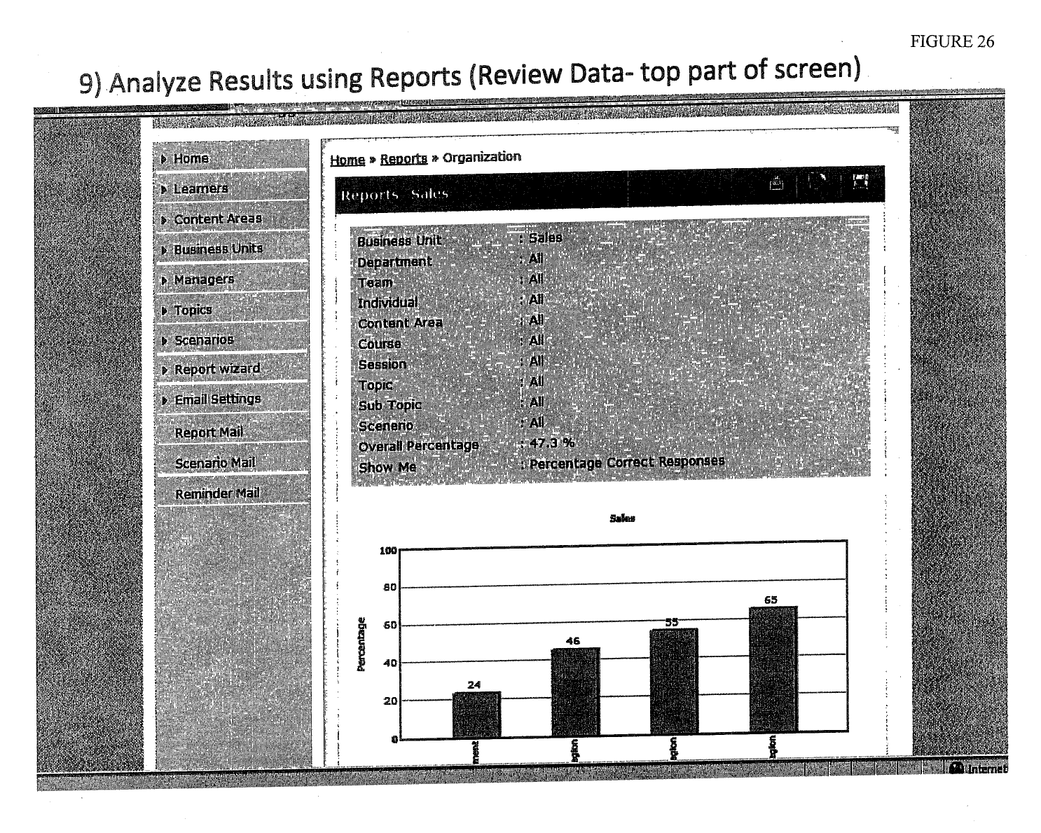

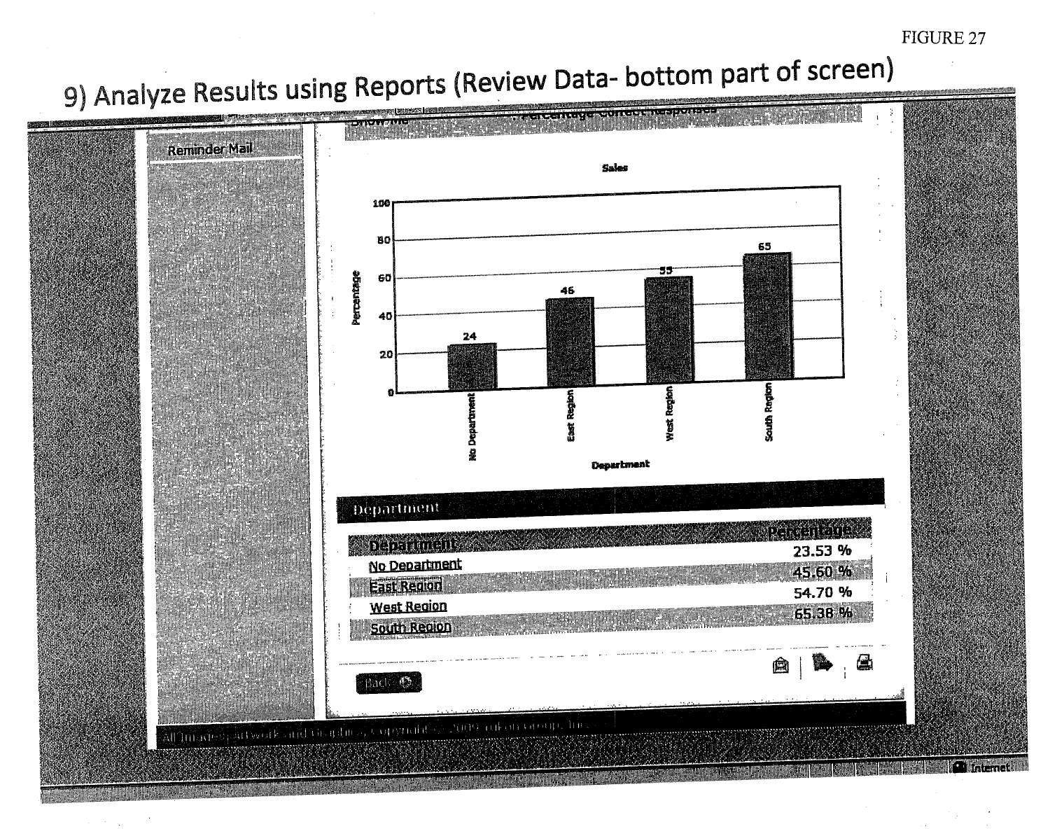

FIGS. 9-27 are representative screen shots of the subject system, method, and computer program product as disclosed herein illustrative of the configurations, settings, report information, content, security, automation, and the like as provided thereby. The representative screen shots illustrate, for instance, the ability to assign scenario/question names with an associated description. The screen shots also highlight, among other things, the various report filters associated with a “report wizard”.

Although the subject disclosure has been described in terms of one or more preferred embodiments, it will be understood that numerous variations and modifications may be made without departing from the scope of the disclosure. Such variations and modifications will become apparent and obvious to one skilled in the art, and all equivalent relationships to those illustrated in the drawings and described in the specification are intended to be encompassed by the present application. Thus, it is to be understood that within the scope of the appended claims, the method, system, or computer program product may be practiced otherwise than as specifically described above.

That which is claimed:

1. A method for reinforcing learning concepts, the method being implemented by a computer, the method comprising:
entering, into a computer-readable storage medium, a plurality of questions and further entering into the computer-readable storage medium two or more possible answers corresponding to each question;
sending, by the computer, a plurality of electronic messages to each of a plurality of participants in a previous learning course;
selecting at least one question from the plurality of entered questions for each one of the plurality of messages;
including the at least one selected question and the two or more possible answers corresponding to the at least one selected question in each electronic message, each of the included questions being related to at least one concept taught in the course, the computer sending a first electronic message to each respective participant within a predetermined time period of a date of the course; and
sending subsequent ones of the plurality of messages, via the computer, to each respective participant at a predetermined frequency.

2. The method of claim 1, wherein each possible answer corresponding to each question has an associated correctness value.

3. The method of claim 2, wherein the associated correctness value is (a) based on an appropriateness scale or (b) based on a designation of correct or incorrect.

4. The method of claim 2, wherein each of the plurality of messages further includes means to enable the participants to select an answer.

5. The method of claim 4, wherein the means to enable the participant to select an answer comprises two or more hyperlinks, each hyperlink associated with one of the possible answers.

6. The method of claim 4, further comprising:
receiving answer selections from one or more of the plurality of participants; and
determining and recording the correctness value for each received answer.

7. The method of claim 6, further comprising:
associating the determined correctness value for each received answer selection with the corresponding participant; and
determining a cumulative grade for each participant based on the determined correctness value for all received answer selections for each participant.

8. The method of claim 7, further comprising:
generating a report comprising at least one of: (a) the cumulative grade for each participant, (b) the determined correctness value for each received answer selection for any one participant or all participants who selected an answer, (c) a cumulative correctness value for each question for all participants who selected an answer, (d) a participant response rate for each question, and (e) the determined cumulated grade for any one participant relative to the determined cumulated grade all other participants.

9. The method of claim 8, wherein each question is categorized by topic and sub-topic, and wherein the report further comprises a cumulative correctness value by topic and/or subtopic for all questions to which participants selected an answer.

10. The method of claim 8, further comprising:
maintaining organizational structure relationship information related to the plurality of participants; and
controlling access to the report and/or content of the report based on the organization structure relationship information.

11. The method of claim 2, further comprising:
sending, in response to each selected answer, an electronic response message to the participant who selected the respective answer, the electronic response message including the associated correctness value corresponding to the respective participant's selected answer and feedback specific to the respective participant's selected answer.

12. The method of claim 11, wherein the electronic response message further includes either (a) information comparing the respective participant's answer selection correctness value to other participants' answer selection correctness value or (b) a hyperlink to information comparing the respective participant's answer selection correctness value to other participants' answer selection correctness value.

13. The method of claim 1, wherein the step of selecting the at least one question from the plurality of entered questions for each one of the plurality of messages comprises selecting the at least one question randomly from the plurality of predetermined questions and corresponding possible answers.

14. The method of claim 1, where the step of selecting the at least one question from the plurality of entered questions for each one of the plurality of messages comprises selecting the same question for each participant's electronic message.

15. The method of claim 1, wherein the at least one question is selected to ensure that not all participants receive the same question at the time or at substantially the same time.

16. The method of claim 1, further comprising:
determining for each sent electronic message whether each participant has selected an answer;
determining an elapsed time since the sending of each electronic message;
comparing the elapsed time to a predetermined time limit; and
sending a reminder electronic message to participants who have not selected an answer if the elapsed time exceeds the predetermined time limit.

17. A computer program product for reinforcing learning concepts, the computer program product comprising at least one computer-readable storage medium having computer-readable program code stored therein, the computer-readable program code comprising:
computer-usable program code for sending, by the computer, a plurality of electronic messages to each of a plurality of participants in a previous training course, each of the plurality of messages including at least one question and two or more corresponding possible answers, each question related to at least one learning concept taught in the course;
wherein the computer-usable program code sends a first one of the plurality of messages to each respective participant within a predetermined time period of a date of the course; and
wherein the computer-usable program code sends subsequent ones of the plurality of messages to each respective participant at a predetermined frequency.

18. The computer program product of claim 17, wherein each possible answer corresponding to each question has an associated correctness value.

19. The computer program product of claim 18, wherein the associated correctness value is (a) based on an appropriateness scale or (b) based on a designation of correct or incorrect.

20. The computer program product of claim 18, wherein each of the plurality of messages further includes means to enable the participants to select an answer.

21. The computer program product of claim 20, wherein the means to enable the participant to select an answer comprises two or more hyperlinks, each hyperlink associated with one of the possible answers.

22. The computer program product of claim 20, further comprising:
computer-usable program code for receiving answer selections from one or more of the plurality of participants; and
computer-usable program code for determining and recording the correctness value for each received answer.

23. The computer program product of claim 22, further comprising:
computer-usable program code for associating the determined correctness value for each received answer selection with the corresponding participant; and
computer-usable program code for determining a cumulative grade for each participant based on the determined correctness value for all received answer selections for each participant.

24. The computer program product of claim 23, further comprising:
computer-usable program code for generating a report comprising at least one of: (a) the cumulative grade for each participant, (b) the determined correctness value for each received answer selection for any one participant or all participants who selected an answer, (c) a cumulative correctness value for each question for all participants who selected an answer, or (d) a participant response rate for each question.

25. The computer program product of claim 24, wherein each question is categorized by topic and sub-topic, and wherein the report further comprises a cumulative correctness value by topic and/or subtopic for all questions to which participants selected an answer.

26. The computer program product of claim 24, further comprising:
computer-usable program code for maintaining organizational structure relationship information related to the plurality of participants; and
computer-usable program code for controlling access to the report and/or content of the report based on the organization structure relationship information.

27. The computer program product of claim 18, further comprising:
computer-usable program code for sending, in response to each selected answer, an electronic response message to the participant who selected the respective answer, the electronic response message including the associated correctness value corresponding to the respective participant's selected answer and feedback specific to the respective participant's selected answer.

28. The computer program product of claim 27, wherein the electronic response message further includes either (a) information comparing the respective participant's answer selection correctness value to other participants' answer selection correctness value or (b) a hyperlink to information comparing the respective participant's answer selection correctness value to other participants' answer selection correctness value.

29. The computer program product of claim 17, further comprising:
computer-usable program code for selecting the at least one question to include in each of the plurality of messages from a plurality of predetermined questions and corresponding possible answers.

30. The computer program product of claim 29, wherein selecting the at least one question comprises selecting the at least one question randomly from the plurality of predetermined questions and corresponding possible answers.

31. The computer program product of claim 29, wherein the at least one question is selected to ensure that not all participants receive the same question at the time or at substantially the same time.

32. The computer program product of claim 17, further comprising:
computer-usable program code for determining for each sent electronic message whether each participant has selected an answer;
computer-usable program code for determining an elapsed time since the sending of each electronic message;
computer-usable program code for comparing the elapsed time to a predetermined time limit; and
computer-usable program code for sending a reminder electronic message to participants who have not selected an answer if the elapsed time exceeds the predetermined time limit.
